(19) United States
(12) Patent Application Publication
(10) Pub. No.: US 2021/0127845 A1
(43) Pub. Date: May 6, 2021

(54) Bed Frame, Locking Arrangement and Method for Assembly of Bed Frame

(71) Applicant: Chaim, Spring Valley, NY (US)

(72) Inventor: Chaim Paskes, Spring Valley, NY (US)

(21) Appl. No.: 16/674,110

(22) Filed: Nov. 5, 2019

(51) Int. Cl. A47C 19/02; A47C 19/00; F16B 12/54

(52) U.S. Cl. CPC A47C 19/021; F16B 12/54; A47C 19/005

(57) ABSTRACT

A locking arrangement for assembly of a bed frame is provided. The locking arrangement comprises a first rail member comprising at least two first projecting interlocking holes and a second rail member comprising at least two sets of second projecting interlocking holes. The locking arrangement further comprises a set of pins such that, in assembled form of the bed frame, the first rail member and the second rail member are disposed in abutment with each other such that each of the at least two first projecting interlocking holes are received within one set of the at least two sets of second projecting interlocking holes to form a provisional locking structure, and each pin of the set of pins is engaged with one of the formed provisional locking structure by passing through the corresponding first projecting interlocking holes and second projecting interlocking holes thereof, to secure the first rail member and the second rail member.

### BACKGROUND OF THE INVENTION

### 1. Field of the Invention

The present disclosure generally relates to bed frames, also known as foundations or bedsteads, for supporting mattresses; and more particularly to bed frames that can be assembled and disassembled by the end user with ease.

### 2. Description of the Related Art

Conventional bed frames, for the most part, consist of a plurality of wood members, usually combined with rigid metal frame members, arranged to form a rectangular box. The bed frames provide a relatively rigid platform on which a mattress or a box spring is placed. The rigid frame members may include several interconnecting members which are assembled into shape of the bed frame for use. These rigid members, generally, include a pair of opposed side rails and a pair of opposed cross-rails, which serve to interconnect the side rails, typically adjacent the ends thereof. Further, legs are ordinarily provided to support the frame. The construction of bed frames has generally relied upon clamps, nuts and bolts, metal screws, and the like for interconnecting the various frame members together and to maintain the proper spacing between the side rails of the frame.

Typical bed frames come pre-assembled from the factory. If the seller or the manufacturer were to ship the parts of the bed frame and leave assembly up to the consumer, the consumer would likely not have the skill to properly assemble the bed frame. Therefore, mostly bed frames are shipped fully assembled despite the extra shipping costs charged for large volume packages. These fully assembled bed frames not only incur shipping penalties, but they are difficult to handle, both during delivery to the consumer and by the consumer once in the consumer's home. For example, it is not uncommon, in the case of larger sized beds that an assembled bed frame is unable to fit up a stairwell, or around certain doors or corners.

Some bed frames are known in the art which allows for easy packaging and shipping in disassembled form, and can be assembled at site by the consumer. However, there are notable disadvantages in assembling the bed frames according to known methods. For example, the known methods require the use of either nuts or bolts, clamps, machine screws, etc. for interconnecting various members, and, as such, these types of fasteners require that the consumer may possess some specialized tools for assembling the bed frame elements, which may not always be the case. Other known methods require the use of clamps to hold the cross-rails together, but this technique presents a further problem, in that the members must be properly aligned before assembly and distance between the side rails shall be accurately determined by a measurement, which may not always be possible for an unskilled consumer trying assembling of the bed frame.

Therefore, it is desired to provide a bed frame which can be disassembled to be made compact for packaging, storage or transport, and further, designed to be easily assembled at site without requiring specialized tools or any specific skill set on part of the user.

Documents describing the closest subject matter provide for a number of more or less complicated features that fail to solve the problems described above in an efficient and economical way. None of the documents suggest the novel features of the present invention.

### SUMMARY OF THE INVENTION

In one aspect of the present disclosure, a locking arrangement for assembly of a bed frame is provided. The locking arrangement comprises a first rail member comprising at least two first projecting interlocking holes. One set of the at least two first projecting interlocking holes is arranged proximal to a top end of the first rail member and other of the at least two first projecting interlocking holes is arranged proximal to a bottom end of the first rail member. The locking arrangement also comprises a second rail member comprising at least two sets of second projecting interlocking holes. One set of the at least two sets of second projecting interlocking holes is arranged proximal to a top end of the second rail member and the other set of the at least two sets of second projecting interlocking holes is arranged proximal to a bottom end of the second rail member. The locking arrangement further comprises a set of pins such that, in assembled form of the bed frame, the first rail member and the second rail member are disposed in abutment with each other such that each of the at least two first projecting interlocking holes are received within one set of the at least two sets of second projecting interlocking holes to form a provisional locking structure, and each pin of the set of pins is engaged with one of the formed provisional locking structure by passing through the corresponding first projecting interlocking holes and the corresponding second projecting interlocking holes thereof, to secure the first rail member and the second rail member.

In another aspect of the present disclosure, a bed frame is provided. The bed frame comprises four panels, including a first panel and a second panel, arranged to form a box structure in the assembled form, with the first panel and the second panel adjoining each other along respective vertical edges thereof. The bed frame comprises a locking arrangement. The locking arrangement comprises a first rail member comprising at least two first projecting interlocking holes. One set of the at least two first projecting interlocking holes is arranged proximal to a top end of the first rail member and the other set of the at least two first projecting interlocking holes is arranged proximal to a bottom end of the first rail member. The first rail member is disposed along the vertical edge of the first panel. The locking arrangement also comprises a second rail member comprising at least two sets of second projecting interlocking holes. One set of the at least two sets of second projecting interlocking holes is arranged proximal to a top end of the second rail member and other of the at least two sets of second projecting interlocking holes is arranged proximal to a bottom end of the second rail member. The second rail member is disposed along the vertical edge of the second panel. The locking arrangement further comprises a set of pins such that, in assembled form of the bed frame, the first rail member and the second rail member are disposed in abutment with each other such that each of the at least two first projecting interlocking holes are received within one set of the at least two sets of second projecting interlocking holes to form a provisional locking structure, and each pin of the set of pins is engaged with one of the formed provisional locking structure by passing through the corresponding first projecting interlocking holes and the corresponding second projecting interlocking holes thereof, to secure the first rail member and the second rail member.

In yet another aspect of the present disclosure, a method of assembling a bed frame is provided. The method comprises providing four panels including a first panel and a second panel. The method further comprises arranging the four panels to form a box structure, with the first panel and the second panel adjoining each other along respective vertical edges thereof such that each of at least two first projecting interlocking holes of a first rail member disposed along a vertical edge of a first panel are received within one set of the at least two sets of second projecting interlocking holes of a second rail member disposed along a vertical edge of a second panel to form a provisional locking structure. The method further comprises providing a set of pins. The method further comprises engaging each pin of the set of pins with one of the formed provisional locking structure by passing through the corresponding first projecting interlocking holes and the corresponding second projecting interlocking holes thereof, to secure the first rail member and the second rail member.

Further aspects and objectives of the present disclosure will be brought out in the following part of the specification, wherein detailed description of embodiments is for the purpose of fully disclosing the invention without placing any limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates a diagrammatic perspective view of a bed frame in disassembled form, in accordance with one or more embodiments of the present disclosure;

FIG. 2A illustrates a diagrammatic perspective view of a first rail member of the bed frame, in accordance with one or more embodiments of the present disclosure;

FIG. 2B illustrates a diagrammatic perspective view of a second rail member of the bed frame, in accordance with one or more embodiments of the present disclosure;

FIG. 3 illustrates a partial diagrammatic view of the bed frame during a step in assembly thereof with the first rail member being received in the second rail member, in accordance with one or more embodiments of the present disclosure;

FIG. 4 illustrates a partial diagrammatic view of the bed frame during a step in assembly thereof, in continuation of the step of FIG. 3, with the first rail member being partly secured to the second rail member using one pin of a set of pins, in accordance with one or more embodiments of the present disclosure;

FIG. 5 illustrates a partial diagrammatic section view of the bed frame during a step in assembly thereof, in continuation of the step of FIG. 4, with the first rail member being fully secured to the second rail member using another pin of the set of pins, in accordance with one or more embodiments of the present disclosure;

FIG. 6 illustrates a diagrammatic section view of the first rail member and the second rail member secured together forming a provisional locking structure with the set of pins received therein, in accordance with one or more embodiments of the present disclosure;

FIG. 7 illustrates a diagrammatic view of the bed frame during a step in assembly thereof with a first panel assembled with a second panel thereof, in accordance with one or more embodiments of the present disclosure;

FIG. 8 illustrates a diagrammatic perspective view of the bed frame in assembled form, in accordance with one or more embodiments of the present disclosure;

FIG. 9 illustrates a diagrammatic perspective view of the bed frame with a folding panel being installed thereon, in accordance with one or more embodiments of the present disclosure; and

FIG. 10 illustrates a diagrammatic perspective view of the bed frame with the folding panel installed thereon, in accordance with one or more embodiments of the present disclosure.

### DETAILED DESCRIPTION OF THE EMBODIMENTS OF THE INVENTION

Illustrative embodiments of the present invention are described below. The following explanation provides specific details for a thorough understanding of and enabling description for these embodiments. One skilled in the art will understand that the invention may be practiced without such details. In some instances, well-known structures, processes, and functions have not been shown or described in detail to avoid unnecessarily obscuring the description of the embodiments.

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

It shall be noted that unless the context clearly requires otherwise, throughout the description, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number, respectively while adhering to the concepts of the present invention. Furthermore, references to “one embodiment” and “an embodiment” are not intended to be interpreted as excluding the existence of additional embodiments that also incorporate the recited features.

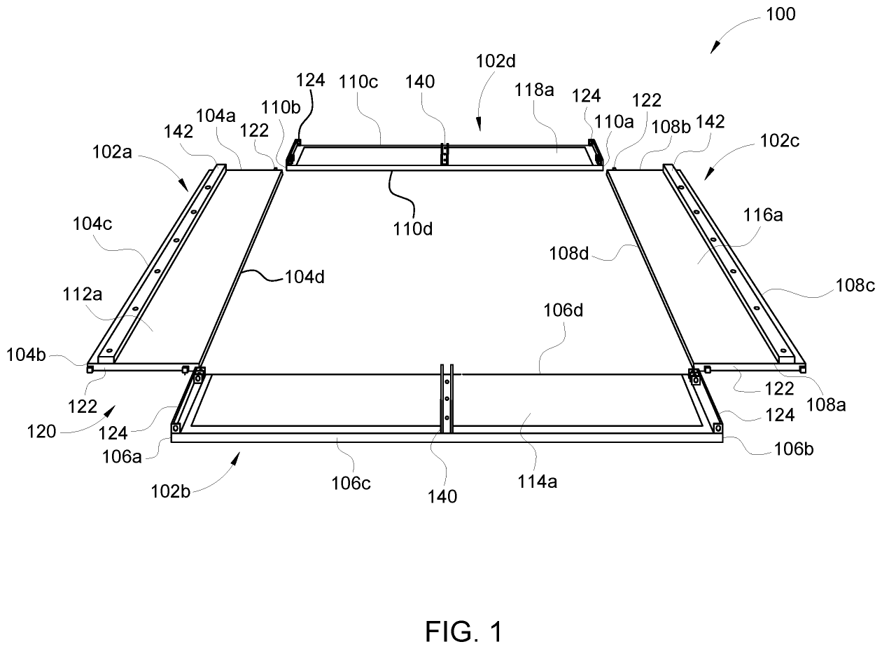

Referring to FIG. 1, illustrated is a diagrammatic view of a bed frame (generally referred by the numeral 100) in disassembled form, in accordance with various embodiments of the present disclosure. As illustrated, the bed frame 100 includes four panels, namely a first panel 102a, a second panel 102b, a third panel 102c and a fourth panel 102d. Hereinafter, the four panels 102a, 102b, 102c and 102d are, sometimes, collectively referred to as “panels” or “four panels” and generally designated by the numeral 102. It may be appreciated that the four panels 102 can be assembled together to form a box-like structure for the bed frame 100, which in turn may be utilized for supporting a mattress, a box spring or the like thereon. Although, in the present examples, the bed frame 100 is shown and described to include four panels 102, it may be appreciated that, in other examples, the bed frame 100 may have three or even more than four number of panels in some cases to provide differently shaped bed frame in the assembled form thereof as per desire and/or requirement of the user, without departing from the scope of the present disclosure.

In the present bed frame 100, the panels 102 are typically constructed of wood material, preferably solid wood. Some of the most common types of wood materials used for constructing the panels 102 may include, but not limited to, oak, mahogany, pine, walnut, maple and the like. The panels 102, made of wood, also may be designed or customized to be unique based on the texture of the wood and the slight variations in color. Further, ornamental carvings or the like may be formed on the panels 102 as desired. In other examples, the panels 102 may be constructed of other suitable materials. For instance, in some examples, the panels 102 may be constructed of metallic materials such as iron or steel, plastic material such as acrylic or plexiglass and the like without any limitations. The panels 102 are usually pre-finished, that is, the panels 102 are pre-coated with desired paints and pre-treated with required chemicals before assembly of the bed frame 100. The panels 102 pre-finished can be made of any material or surface because the panels 102 are not disturbed by the installation process.

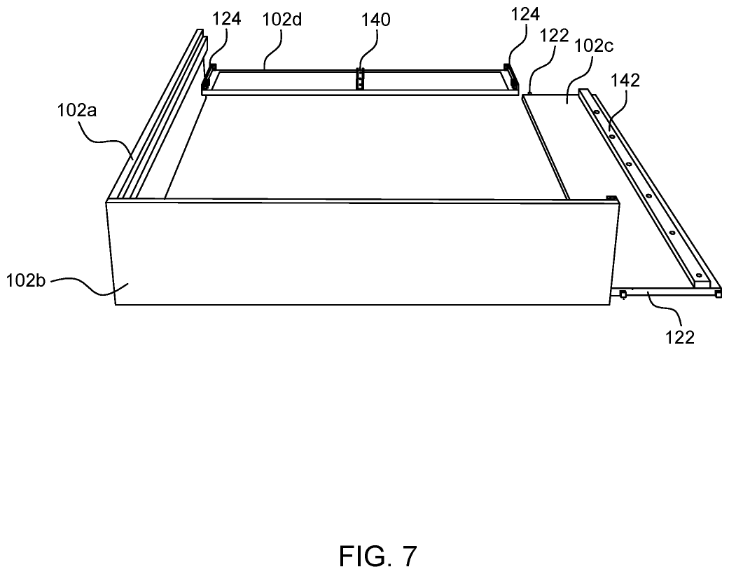

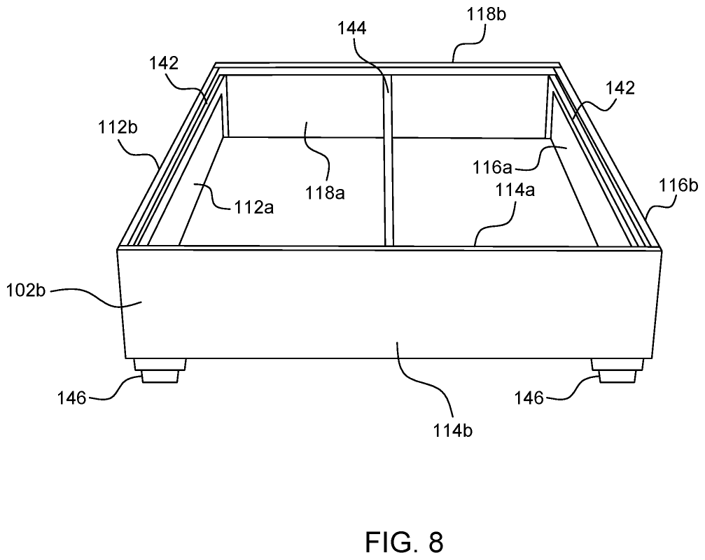

In the present examples, each of the four panels 102 are generally rectangular structures. Each of such panel 102 includes two vertical edges and two horizontal edges, typically with the horizontal edges longer than vertical edges thereof. For example, the first panel 102a includes a first vertical edge 104a, a second vertical edge 104b, a first horizontal edge 104c and a second horizontal edge 104d; and the second panel 102b includes a first vertical edge 106a, a second vertical edge 106b, a first horizontal edge 106c and a second horizontal edge 106d. Similarly, the third panel 102c includes a first vertical edge 108a, a second vertical edge 108b, a first horizontal edge 108c and a second horizontal edge 108d; and the fourth panel 102d includes a first vertical edge 110a, a second vertical edge 110b, a first horizontal edge 110c and a second horizontal edge 110d. Each of the panels 102 include an inner surface and an outer surface. In the illustration of FIG. 1, only inner surfaces of the panels 102 are visible. In FIGS. 7-9, depicting assembled form of the bed frame 100, the outer surfaces for the panels 102 have been generally labelled for reference purposes. Referring to the FIGS. 1 and 8 in combination, herein, the first panel 102a includes an inner surface 112a and an outer surface 112b, the second panel 102b includes an inner surface 114a and an outer surface 114b, the third panel 102c includes an inner surface 116a and an outer surface 116b, and the fourth panel 102d includes an inner surface 118a and an outer surface 118b.

In the illustration of FIG. 1, the four panels 102 are depicted to be laid flat, say, on ground or any flat surface, for assembly of the bed frame 100. But, the bed frame 100 may be assembled on uneven surface. Generally, for assembly of the bed frame 100, the four panels 102 are arranged in alignment with each other, to complete assembly of the bed frame 100. As illustrated, each of the four panels 102 are arranged with their vertical edges next or adjacent to vertical edges of two of the neighboring panels. As may be seen, the first panel 102a and the second panel 102b are placed adjacent to and adjoining each other along their vertical edges 104b and 106a, respectively. Similarly, the second panel 102b and the third panel 102c are placed adjacent to and adjoining each other along their vertical edges 106b and 108a, respectively; the third panel 102c and the fourth panel 102d are placed adjacent to and adjoining each other along their vertical edges 108b and 110a, respectively; and the fourth panel 102d and the first panel 102a are placed adjacent to and adjoining each other along their vertical edges 110b and 104a, respectively.

According to embodiments of the present disclosure, the bed frame 100 includes a locking arrangement 120. The locking arrangement 120 includes a plurality of first rail members 122 and second rail members 124. Herein, the first rail members 122 and the second rail members 124 are interconnecting members arranged along the vertical edges of the panels 102. In the illustrated embodiment, the first panel 102a is shown to include two first rail members 122 along each of the two vertical edges 104a and 104b thereof, the second panel 102b is shown to include two second rail members 124 along each of the two vertical edges 106a and 106b thereof, the third panel 102c is shown to include two first rail members 122 along each of the two vertical edges 108a and 108b thereof, and the fourth panel 102d is shown to include two second rail members 124 along each of the two vertical edges 110a and 110b thereof. It may be appreciated that the neighboring panels 102 of the bed frame 100 are provided with one or other of the first rail members 122 and the second rail members 124. In an alternate embodiment, each of the panels 102 may be provided with one first rail member 122 along one of their vertical edge and the second rail member 124 along other of their vertical edge, such that the neighboring panels 102 are arranged with the first rail member 122 and the second rail member 124 disposed in adjacent to each other when the vertical edges of the corresponding panels are aligned for assembly of the bed frame 100.

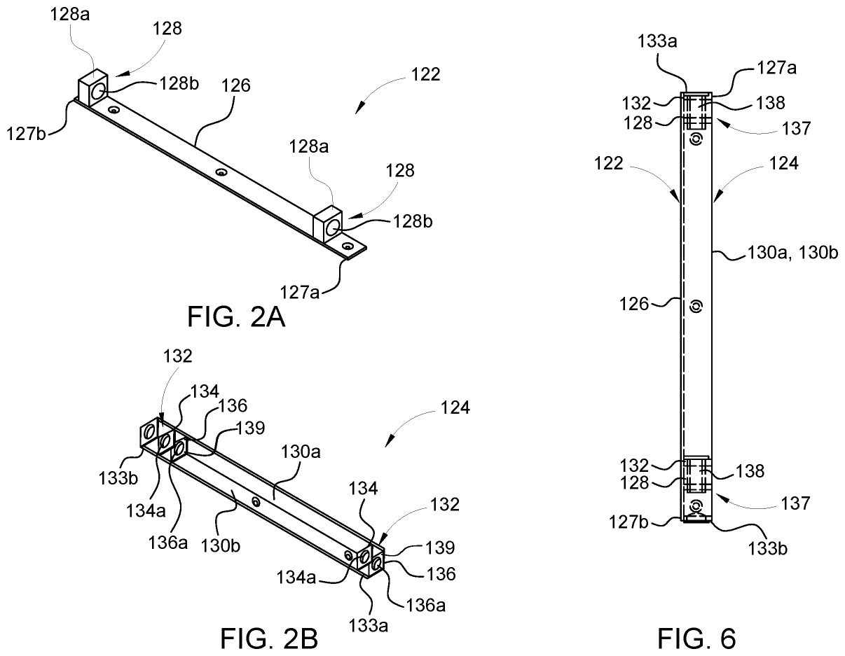

FIG. 2A illustrates a diagrammatic perspective view of the first rail member 122 and FIG. 2B illustrates a diagrammatic perspective view of the second rail member 124, respectively. In the present examples, the first rail member 122 and the second rail member 124 are metal rails. For instance, the first rail member 122 and the second rail member 124 may be made of metallic materials, such as iron or steel. As illustrated, the first rail member 122 and the second rail member 124 are generally in the form of elongated brackets which can be interlocked with each other. As illustrated in FIG. 2A, the first rail member 122 includes an elongated plate 126. The first rail member 122 includes at least two first projecting interlocking holes 128, extending from the elongated plate 126. In the illustrated examples, the first rail member 122 includes two number of first projecting interlocking holes 128. Herein, one of the two first projecting interlocking holes 128 is arranged proximal to a top end 127a of the first rail member 122 and the other of the at least two first projecting interlocking holes 128 is arranged proximal to a bottom end 127b of the first rail member 122. As may be seen, each of the two first projecting interlocking holes 128 includes a bracket 128a, with a hole 128b, protruding orthogonally from the elongated plate 126 of the first rail member 122. Further, as illustrated in FIG. 2B, the second rail member 124 includes two elongated plates 130a and 130b joined to have a L-shaped cross-section. The second rail member 124 includes at least two sets of second projecting interlocking holes 132. In the illustrated examples, the second rail member 124 includes two number of sets of second projecting interlocking holes 132. Herein, one set of the two sets of second projecting interlocking holes 132 is arranged proximal to a top end 133a of the second rail member 124 and the other set of the two sets of second projecting interlocking holes 132 is arranged proximal to a bottom end 133b of the second rail member 124. In the illustrated examples, each of the set of second projecting interlocking holes 132 includes two or more projecting interlocking holes with spaces in between sufficient for receiving the first projecting interlocking holes 128. Herein, each set of the two sets of second projecting interlocking holes 132 include an upper bracket 134 and a lower bracket 136, with each bracket having one corresponding hole 134a and 136a respectively. The upper bracket 134 and the lower bracket 136 are protruding parallel to each other and orthogonally from and between the two elongated plates 130a and 130b of the second rail member 124.

It may be appreciated by a person skilled in the art that the sets of second projecting interlocking holes 132 are adapted to receive projecting interlocking holes, such as the first projecting interlocking holes 128 therein. Herein, the first projecting interlocking holes 128, or specifically the brackets 128a may have certain thickness. Further, in each of the set of second projecting interlocking holes 132, the brackets 134 and 136 have spaces in between sufficient for receiving the bracket 128a of the first projecting interlocking holes 128. In some examples, one or more sets of second projecting interlocking holes 132 include more than two projecting interlocking holes 132 to allow for adjustment of height of the first rail member 122 with respect to the second rail member 124, if required. Therefore, when the first rail member 122 and the second rail member 124 are disposed in abutment with each other, each of the two first projecting interlocking holes 128 are received within one set of the two sets of second projecting interlocking holes 130, to form a provisional locking structure (as shown and generally designated by the numeral 137 and discussed in detail later in the description with reference to FIG. 6). It may be understood that when each of the two first projecting interlocking holes 128 are received within one of the two sets of second projecting interlocking holes 130, the holes 128b in the first rail member 122 are aligned with the holes 134a and 136a in the second rail member 124, in the provisional locking structure.

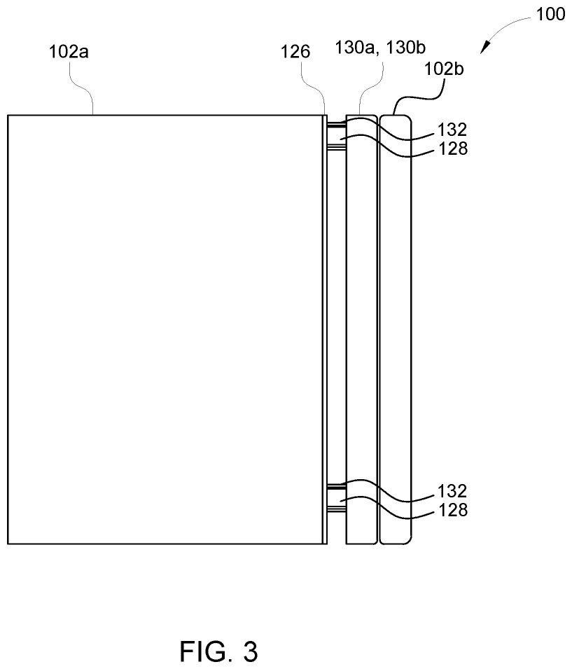

It may be contemplated from FIG. 1 that for assembly of the bed frame 100, the panels 102 are lifted from the ground with one of their horizontal edges (herein, the second horizontal edges 104d, 106d, 108d and 110d) staying in contact with the ground and the neighboring panels 102 having one of their respective vertical edges next to each other. FIG. 3 illustrates a partial diagrammatic view of the bed frame 100 during a step in assembly thereof with the first rail member 122 being received in the second rail member 124. Herein, the bed frame 100 is depicted with the first panel 102a and the second panel 102b lifted and disposed next to each other such that the vertical edge 104b of the first panel 102a is adjacent to and in alignment with the vertical edge 106a of the second panel 102b. In this arrangement, the first rail member 122 and the second rail member 124 are disposed in abutment with each other such that each of the two first projecting interlocking holes 128 are received within one set of the two sets of second projecting interlocking holes 132 to form the provisional locking structure (as discussed in the preceding paragraphs).

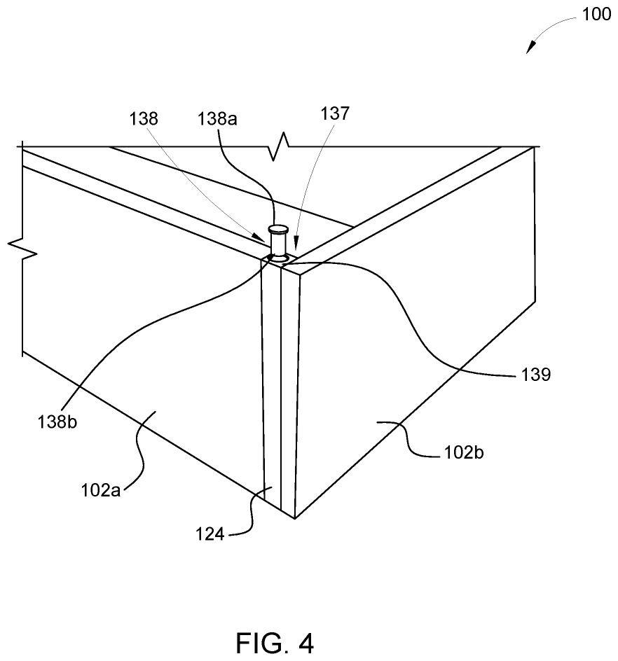

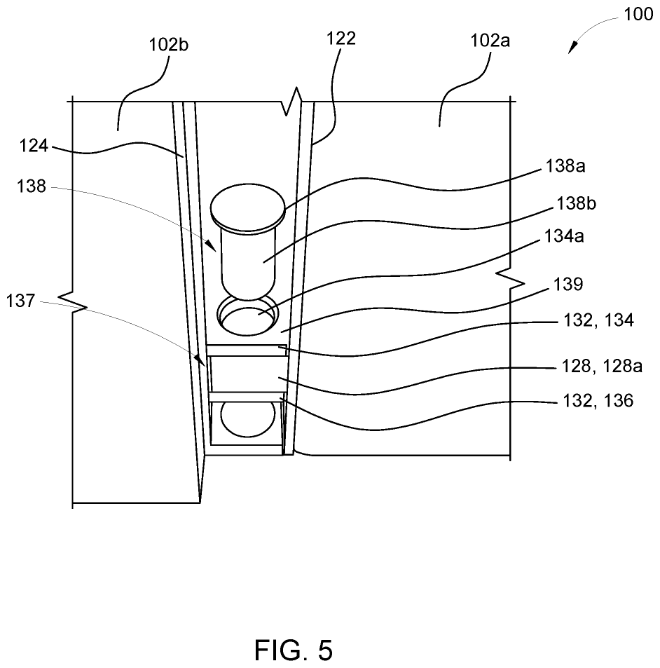

FIGS. 4-5 illustrate diagrammatic views of the bed frame during subsequent steps in assembly thereof. In embodiments of the present disclosure, the locking arrangement 120 further includes a set of pins 138. In the present examples, the locking arrangement 120 includes two pins 138. Each pin of the two pins 138 is engaged with one of the formed provisional locking structure by passing through the corresponding first projecting interlocking holes 128 and the corresponding second projecting interlocking holes 132, to secure the first rail member 122 and the second rail member 124. Specifically, each of the two pins 138 is engaged with holes 134a, 128b and 136a aligned with each other, in the provisional locking structure. In FIG. 4, the first rail member 122 is shown partly secured to the second rail member 124 by using one of the two pins 138 engaged with the provisional locking structure formed near top ends 127a and 133a of the first rail member 122 and the second rail member 124, while assembling the first panel 102a and the second panel 102b together. In FIG. 5, the first rail member 122 is shown fully secured to the second rail member 124 by further using other of the two pins 138 engaged with the provisional locking structure formed near bottom ends 127b and 133b of the first rail member 122 and the second rail member 124, while assembling the first panel 102a and the second panel 102b together.

FIG. 6 illustrates a diagrammatic section view of the first rail member 122 and the second rail member 124 secured together. The first rail member 122 and the second rail member 124 are coupled to each other, to form an interconnecting spine like structure with solid connection along entire lengths thereof. As may be seen, the first rail member 122 and the second rail member 124 are disposed in abutment with each other such that each of the two first projecting interlocking holes 128 are received within one set of the two sets of second projecting interlocking holes 132 to form the provisional locking structures 137 proximal to the top ends 127a and 133a and the bottom ends 127b and 133b of the first rail member 122 and the second rail member 124, respectively. Further, as may be seen, the pins 138 are received in the formed provisional locking structures 137 to secure the first rail member 122 and the second rail member 124.

In the present examples, each of the set of pins 138 is a push pin. The pins 138 are generally thicker and have tight tolerances for inserting into and engaging with holes in the provisional locking structure 137. That is, the pin 138 may simply be pushed into the aligned holes of the provisional locking structure 137, without the need of any specialized tool. The pin 138 may be received and retained in the provisional locking structure 137 by means of gravity. As better illustrated in FIGS. 4 and 5, each pin 138 includes a head 138a and a shaft 138b. Herein, the shaft 138b is a straight cylindrical structure. In some examples, the upper bracket 134 has a recess 139 (also labelled in FIG. 2B) defined therein. The recess 139 may be in the form of a groove or depression formed in an upper projecting surface of the upper bracket 134. The head 138a of the pin 138 is seated in the recess 139 for providing stability and for proper engagement of the pin 138 with the provisional locking structure 137. It may be contemplated that a user may only need to push the pin 138 (with his/her thumb or the like) at the head 138a thereof, and the straight cylindrical shaft 138b may get inserted into the holes of the corresponding provisional locking structure 137 without the need of any specialized tools or any particular skills, in order to secure the first rail member 122 and the second rail member 124 and thereby complete a step in assembly of the bed frame 100.

FIG. 7 illustrates a diagrammatic view of the bed frame 100 during a step in assembly thereof, depicting the first panel 102a assembled with the second panel 102b thereof. As discussed, when the first rail member 122 and the second rail member 124 are secured together, the corresponding first panel 102a and the second panel 102b are also secured with each other. The first panel 102a and the second panel 102b are adjoining each other along respective vertical edges thereof. It may be contemplated that in a similar manner, the second panel 102b is secured with the third panel 102c, the third panel 102c is secured with the fourth panel 102d, and the fourth panel 102d is secured with the first panel 102a, to cause the assembly of the bed frame 100. FIG. 8 illustrates a diagrammatic perspective view of the bed frame 100 in assembled form. It may be appreciated that, in the assembled form, the bed frame 100 provides a box-like structure. The assembled bed frame 100 may be square (with all the panels 102 having same lengths) or rectangular (with the opposing panels 102 having same length and the adjacent panels 102 having different lengths) without any limitations.

Referring back to FIG. 1, as illustrated, the bed frame 100 includes two channels 140 arranged vertically along substantially middle of two horizontal edges of two opposing panels of the four panels 102. In the present examples, one of the two channels 140 is fixed to the second panel 102b, vertically arranged at middle of the horizontal edges 106c and 106d; and other of the two channels 140 is fixed to the fourth panel 102d, vertically arranged at middle of the horizontal edges 110c and 110d. The two channels 140 are fixed to inner surfaces 114a and 116a of the second panel 102b and the fourth panel 102d respectively. The two channels 140 are parallel to respective vertical edges of the corresponding panels, and are generally in line with each other. Further, as illustrated in FIG. 1, the bed frame 100 includes two supporting slats 142 arranged horizontally along the first (upper) horizontal edges of two opposing panels of the four panels 102. In the present examples, one of the two supporting slats 142 is fixed to the first panel 102a along the first horizontal edge 104c thereof; and other of the two supporting slats 142 is fixed to the third panel 102c along the first horizontal edge 108c thereof.

Referring again to FIG. 8, as illustrated, the bed frame 100 includes a slat panel 144 engaged with and arranged between the two opposing channels 140 (not shown herein). The slat panel 144 is generally arranged in the center of the assembled bed frame 100, parallel to the first panel 102a and the third panel 102c. The slat panel 144 goes all the way down along vertical length of the panels 102 to provide additional support to the bed frame 100. This way the slat panel 144 also acts as a reinforcing member for the bed frame 100. In some examples, as illustrated in FIG. 8, the bed frame 100 includes one or more bumpers 146 arranged along second (lower) horizontal edges of each of the four panels 102. In the present examples, the bed frame 100 includes two bumpers 146 arranged along each of the second horizontal edges of the four panels 102. In the illustration of FIG. 8, the bed frame 100 is shown to include only two bumpers 146 arranged at corners of the second horizontal edge 106d of the second panel 102c; however, it may be appreciated that the other panels 102a, 102c and 102d of the bed frame 100 may also include two bumpers 146 at the respective second horizontal edges 104d, 108d and 110d. In the present examples, the one or more bumpers 146 are square bumpers made of rubber or other suitable cushioning material. Such bumpers are well known and widely available in the art. The bumpers 146 may be installed to the panels 102, either before or after assembling of the panels 102 of the bed frame 100. It may be appreciated that the bumpers 146 provide cushioning and protection against shock to the bed frame 100.

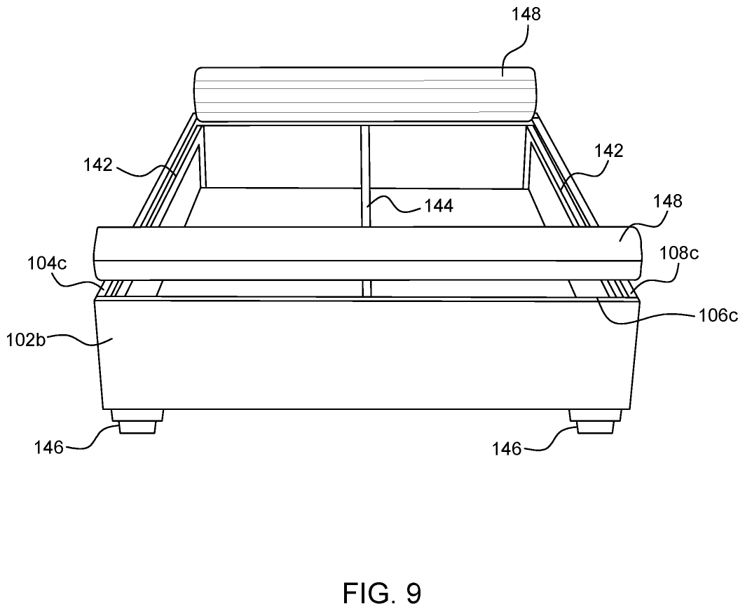

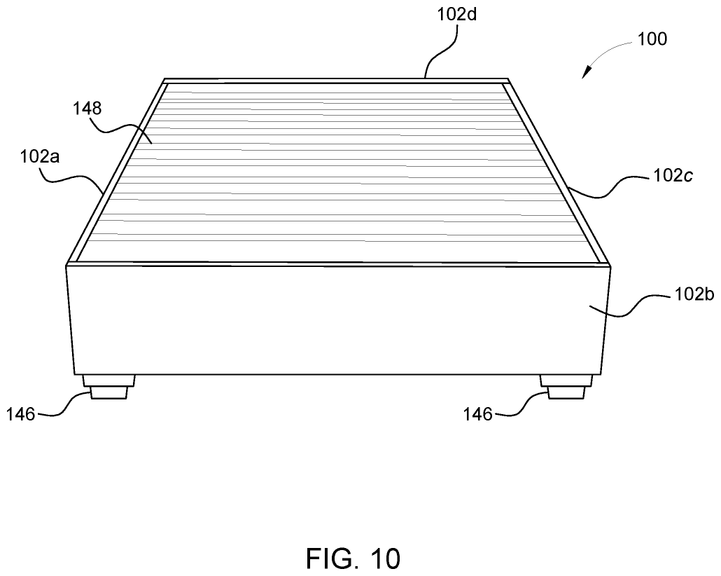

Referring to FIGS. 9-10, as illustrated, the bed frame 100 includes a folding panel 148. In the present examples, the bed frame 100 is shown to include two folding panels 148. The folding panels 148 are supported on the panels 102 and the slat panel 144 of the bed frame 100 in unfolded form thereof, as shown. In particular, the folding panels 148 are supported on the supporting slats 142 of the opposing panels 102a and 102c, and further on the slat panel 144 between the opposing panels 102b and 102d, in the bed frame 100. It may be appreciated that the folding panels 148 are provided in folded form (as shown in FIG. 10) for easy packaging and transportation thereof. The folding panels 148 can easily be unfolded to form a flat surface (as shown in FIG. 10) on the bed frame 100 for supporting a mattress or the like.

The present disclosure further provides a method of assembling a bed frame (such as, the bed frame 100 of FIG. 1). The method comprises providing four panels (such as, the panels 102) including a first panel (such as, the first panel 102a) and a second panel (such as, the second panel 102b). The method further comprises arranging the four panels 102 to form a box structure, with the first panel 102a and the second panel 102b adjoining each other along respective vertical edges (like the vertical edges 104b and 106a) thereof such that each of the at least two first projecting interlocking holes (such as, the first projecting interlocking holes 128) of a first rail member (such as, the first rail member 122) disposed along the vertical edge 104b of the first panel 102a are received within one set of the at least two sets of second projecting interlocking holes (such as, the second projecting interlocking holes 132) of a second rail member (such as, the second rail member 124) disposed along the vertical edge 106a of the second panel 102b to form a provisional locking structure (such as, the provisional locking structure 137). The method further comprises providing a set of pins (such as, pins 138). The method further comprises engaging each pin of the set of pins 138 with one of the formed provisional locking structure 137, passing through the corresponding first projecting interlocking holes 128 and the corresponding second projecting interlocking holes 132 thereof, to secure the first rail member 122 and the second rail member 124.

The bed frame 100 of the present disclosure can be easily assembled and disassembled by a user. The design of the bed frame 100 allows for rigidly interconnecting the rail members 122 and 124. The rail members 122 and 124 provide a mechanism for interconnecting the panels 102 of the bed frame 100 with a positive interlock between those portions. As described in the aforementioned method, the use may need to align the panels 102 with their vertical edges placed adjacent to each other. The user may then arrange the panels 102 such that for each of the pair of panels 102 adjacent to each other, the corresponding rail members 122 and 124 are interlocked with each other to form provisional locking structures 137. The user may then simply utilize pins 138 and push the pins 138 into the formed provisional locking structures 137 between the rail members 122 and 124 for securing thereof, without requiring the use of any tools or any specialized skills. Since the locking arrangement 120 of the present disclosure is arranged on the inside of the panels 102, with no screws or bolts on the outside, this allows for using pre-finished panels 102 because the panels 102 are not disturbed by the installation.

The use of set of pins 138, with one pin 138 for each of the formed provisional locking structure 137 provides more secure interconnection for securing the rail members 122 and 124. The pins 138 simply drop into the holes in the provisional locking structures 137 and are held in place by gravity (without the need to hammer or screw the pin into the hole). The shaft 138b of the pin 138 being straight and not tapered further helps to simply drop the pin 138 into the holes in the provisional locking structures 137. The pins 138 are further easy to uninstall by simply pushing out. The use of set of pins 138 allows for assembly of higher vertical length bed frames 100 with ease. This makes it easier for the user to assemble as well as disassemble the bed frame 100, in contrast to existing art which generally utilize single long screws or the like for each interconnection and which are generally harder to insert and cumbersome to handle.

All references, including publications, patent applications, and patents, cited herein are hereby incorporated by reference to the same extent as if each reference were individually and specifically indicated to be incorporated by reference and were set forth in its entirety herein.

The detailed description set forth herein in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein, but is to be accorded the widest scope consistent with the principles and novel features disclosed herein. It is contemplated that additional embodiments are within the spirit and true scope of the disclosed subject matter.

What is claimed is:

1. A locking arrangement for assembly of a bed frame, comprising:
a first rail member comprising at least two first projecting interlocking holes, wherein one of the at least two first projecting interlocking holes is arranged proximal to a top end of the first rail member and the other of the at least two first projecting interlocking holes is arranged proximal to a bottom end of the first rail member;
a second rail member comprising at least two sets of second projecting interlocking holes, wherein one set of the at least two sets of second projecting interlocking holes is arranged proximal to a top end of the second rail member and the other set of the at least two sets of second projecting interlocking holes is arranged proximal to a bottom end of the second rail member; and
a set of pins,
wherein, in assembled form of the bed frame:
the first rail member and the second rail member are disposed in abutment with each other such that each of the at least two first projecting interlocking holes are received within one set of the at least two sets of second projecting interlocking holes to form a provisional locking structure, and
each pin of the set of pins is engaged with one of the formed provisional locking structure by passing through the corresponding first projecting interlocking holes and the corresponding second projecting interlocking holes thereof, to secure the first rail member and the second rail member.

2. The locking arrangement of claim 1, wherein the first rail member includes an elongated plate, and wherein each of the at least two first projecting interlocking holes includes a bracket, with a hole, protruding orthogonally from the elongated plate of the first rail member.

3. The locking arrangement of claim 2, wherein the second rail member includes two elongated plates joined to have a L-shaped cross-section, and wherein each of the at least two sets of second projecting interlocking holes include an upper bracket and a lower bracket, with each having one corresponding hole, protruding parallel to each other and orthogonally from and between the two elongated plates of the second rail member.

4. The locking arrangement of claim 3, wherein each pin of the set of pins is a push pin with a head and a shaft, wherein the shaft is a straight cylindrical structure.

5. The locking arrangement of claim 4, wherein the upper bracket has a recess defined therein, and wherein the head of the pin is seated in the recess.

6. The locking arrangement of claim 1, wherein the bed frame comprises four panels, including a first panel and a second panel, arranged to form a box structure in the assembled form, with the first panel and the second panel adjoining each other along respective vertical edges thereof, wherein the first rail member is disposed along the vertical edge of the first panel and the second rail member is disposed along the vertical edge of the second panel.

7. The locking arrangement of claim 1, wherein the first rail member and the second rail member are metal rails.

8. A bed frame, comprising:
four panels, including a first panel and a second panel, arranged to form a box structure in the assembled form, with the first panel and the second panel adjoining each other along respective vertical edges thereof; and
a locking arrangement comprising:
a first rail member comprising at least two first projecting interlocking holes, wherein one of the at least two first projecting interlocking holes is arranged proximal to a top end of the first rail member and the other of the at least two first projecting interlocking holes is arranged proximal to a bottom end of the first rail member, and wherein the first rail member is disposed along the vertical edge of the first panel;
a second rail member comprising at least two sets of second projecting interlocking holes, wherein one set of the at least two sets of second projecting interlocking holes is arranged proximal to a top end of the second rail member and the other set of the at least two sets of second projecting interlocking holes is arranged proximal to a bottom end of the second rail member, and wherein the second rail member is disposed along the vertical edge of the second panel; and
a set of pins,
wherein, in the assembled form of the bed frame:
the first rail member and the second rail member are disposed in abutment with each other such that each of the at least two first projecting interlocking holes are received within one set of the at least two sets of second projecting interlocking holes to form a provisional locking structure, and
each pin of the set of pins is engaged with one of the formed provisional locking structure by passing through the corresponding first projecting interlocking holes and the corresponding second projecting interlocking holes thereof, to secure the first rail member and the second rail member.

9. The bed frame of claim 8, wherein the first rail member includes an elongated plate, and wherein each of the at least two first projecting interlocking holes includes a bracket, with a hole, protruding orthogonally from the elongated plate of the first rail member.

10. The bed frame of claim 8, wherein the second rail member includes two elongated plates joined to have a L-shaped cross-section, and wherein each set of the at least two sets of second projecting interlocking holes include an upper bracket and a lower bracket, with each bracket having one corresponding hole, protruding parallel to each other and orthogonally from and between the two elongated plates of the second rail member.

11. The bed frame of claim 8, wherein the four panels are pre-finished rectangular panels.

12. The bed frame of claim 8 further comprising two channels arranged vertically along substantially middle of two horizontal edges of two opposing panels of the four panels.

13. The bed frame of claim 12 further comprising a slat panel engaged with and arranged between the two opposing channels.

14. The bed frame of claim 13 further comprising a folding panel supported on the four panels and the slat panel, in unfolded form thereof.

15. The bed frame of claim 8 further comprising one or more bumpers arranged along a lower horizontal edge of each of the four panels.

16. The bed frame of claim 15, wherein the one or more bumpers are square bumpers.

17. A method of assembling a bed frame, comprising:
providing four panels including a first panel and a second panel;
arranging the four panels to form a box structure, with the first panel and the second panel adjoining each other along respective vertical edges thereof such that each of at least two first projecting interlocking holes of a first rail member disposed along a vertical edge of a first panel are received within one set of at least two sets of second projecting interlocking holes of a second rail member disposed along a vertical edge of a second panel to form a provisional locking structure;
providing a set of pins; and
engaging each pin of the set of pins with one of the formed provisional locking structure by passing through the corresponding first projecting interlocking holes and the corresponding second projecting interlocking holes thereof, to secure the first rail member and the second rail member.

18. The method of claim 17 further comprising pushing each pin of the set of pins into one of the formed provisional locking structure.

19. The method of claim 17 further comprising:
providing one or more bumpers; and
arranging the one or more bumpers along a lower horizontal edge of each of the four panels;

20. The method of claim 17 further comprising:
providing two channels;
arranging the two channels vertically along substantially middle of two horizontal edges of two opposing panels of the four panels;
providing a slat panel;
arranging the slat panel between the two opposing channels;
providing a folding panel; and
supporting the folding panel, in unfolded form, on the four panels and the slat panel.
